(19) United States
(12) Patent Application Publication
(10) Pub. No.: US 2012/0216352 A1
(43) Pub. Date: Aug. 30, 2012

(54) MULTI-FUNCTION TOOL FOR PRYING AND LEVERAGE-ENHANCED GRIPPING

(76) Inventors: Wayne Fisher, Englewood, WA (US); Marilyn Crawford, Tacoma, WA (US)

(21) Appl. No.: 13/035,935

(22) Filed: Feb. 26, 2011

(51) Int. Cl. B25F 1/00

(52) U.S. Cl. 7/166

(57) ABSTRACT

A multi-function tool is disclosed which provides prying as well as leverage-enhanced gripping capability. By combining the lever arm of a prying bar with the gripping capability of gripping pliers, this multi-function tool provides leverage-enhanced gripping and leveraged-forced movement of objects. The lever action of the prying bar can be applied via the gripping pliers, thereby allowing a user to exert more force via the gripping pliers than is possible by using gripping pliers alone. In some embodiments, the prying bar is a crowbar, and the gripping pliers are vice grips. In preferred embodiments, the prying bar and the gripping pliers are welded together.

### FIELD

The invention generally relates to tools, and more specifically to leverage-based tools.

### BACKGROUND

Construction of living, work, and/or recreational space is an important part of modern society. Demolition of structures is equally important, for example when whole structures or portions of structures require renovation, replacement, or total elimination. While machines can be used in demolishing structures on a large scale, manual demolition tools are still important for more targeted demolition activities.

Crowbars are useful manual demolition tools that use leverage to force and pry objects open, and generally break construction materials apart. However, as useful as crowbars are at demolition tasks due to the powerful leverage that they apply, there are functions they cannot perform. For example, while crowbars can provide lever action for prying objects apart, and can be used to remove nails, crowbars typically are not able to grip and pull some objects that are not shaped like nails so as to remove them from structures to be demolished. This limitation restricts the amount of leverage-based demolition work that can be easily accomplished manually.

### SUMMARY

A multi-function leverage-based tool is provided that can perform both prying functions of a prying bar, such as a crowbar, while also providing leverage-enhanced gripping capabilities. By combining the lever arm of a prying bar with the gripping capability of gripping pliers, this improved multi-function tool can provide leverage-enhanced gripping and leverage-based manipulation of objects.

The multi-function tool includes a prying bar joined to gripping pliers, which can be used to manually grip and manipulate objects, thereby making this multi-function tool superior to known prying bars. Furthermore, the lever action offered by the prying bar can increase the force applied via the gripping pliers as compared with gripping pliers alone, thereby also making this multi-function tool superior to known gripping pliers. The synergistic combination of lever-action and gripping capabilities provides a versatility and a level of effectiveness that is not found in other manual demolition devices.

A general aspect of the invention is a multi-function tool for prying and leverage-enhanced gripping. The multi-function tool includes: a prying bar, the prying bar having at least one fulcrum end; and gripping pliers attached to the prying bar in substantially parallel alignment, the gripping pliers having a pair of grippers for gripping an object, the grippers being located proximal to the fulcrum end, so as to enable a user to use the prying bar for applying leverage to the gripping pliers while the grippers grip an object, thereby providing leverage-enhanced gripping of the object.

In some embodiments, the at least one fulcrum end is curved. In some embodiments, at least one end of the prying bar includes an angled bend. In some embodiments, at least one end of the prying bar includes a fissure capable of removing nails. In one embodiment, a shaft of the prying bar is shaped in a circular cross-section, a hexagonal cross-section, or an I-beam cross-section. In some embodiments, the prying bar is made from steel, iron, and titanium. In some embodiments, the prying bar is a crowbar.

In some embodiments, the gripping pliers are locking pliers. In some embodiments, the gripping pliers are a locking wrench. In some embodiments, the gripping pliers are vise grips. In some embodiments, the grippers are made substantially from steel. In some embodiments, the gripping pliers are attached directly to the prying bar.

In some embodiments, the gripping pliers are attached via an intermediary attachment element. In some embodiments, the gripping pliers are welded to the prying bar. In some embodiments, the gripping pliers are screwed to the prying bar and/or bolted to the prying bar.

### BRIEF DESCRIPTION OF THE DRAWINGS

The invention will be more fully understood by reference to the detailed description, in conjunction with the following figures, wherein:

FIG. 1 is a side-view of an embodiment of the multi-function tool;

FIG. 2 is a side-view of an alternative embodiment of the multi-function tool;

FIG. 3A is a side-view of another embodiment of the multi-function tool being used to pull a nail out of a board with gripping pliers, using a prying bar for leverage;

FIG. 3B is a side-view of the embodiment of FIG. 3A being used as a regular prying bar to remove the nail;

FIG. 4 is an oblique side-view of an embodiment of the multi-function tool being used to provide extra leverage for leverage-enhanced gripping of a skid plate;

FIG. 5 is an oblique view of an embodiment of the multi-function tool being used to provide leveraged gripping of a window extrusion; and

FIG. 6 is a flowchart detailing steps for using an embodiment of the multi-function tool.

### DETAILED DESCRIPTION

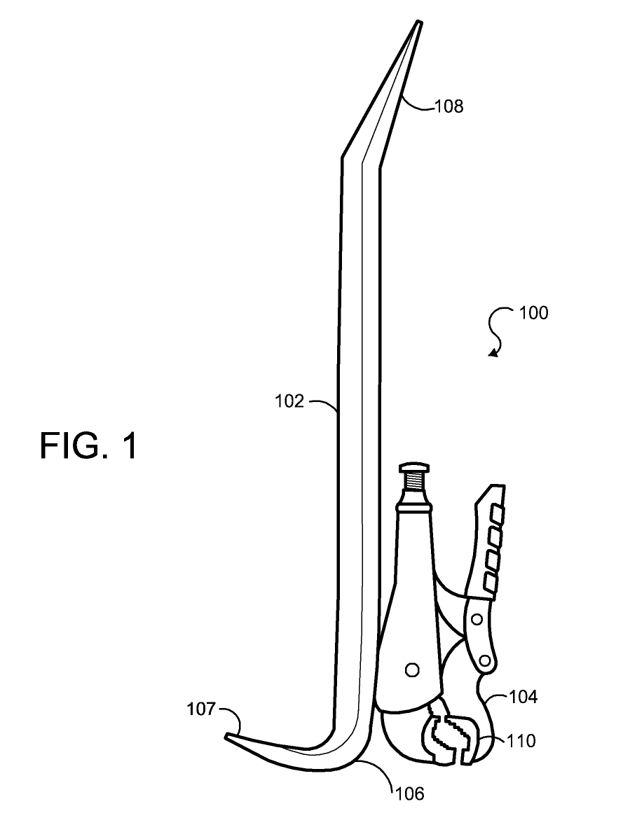

FIG. 1 is a side-view illustration of an embodiment of the multi-function tool. The multi-function tool 100 includes a prying bar 102 and a pair of gripping pliers 104 attached to the prying bar 102. The prying bar 102 can be a crowbar, or any other bar that uses leverage to pry apart objects. In the embodiment shown, the prying bar 102 is a crowbar which contains a fulcrum end 106, the fulcrum end in this figure being in the shape of a goose-necked curved portion 106 and including a fissure 107, and an opposite end 108 opposite the fulcrum end, the handle end 108 including an angled bend 108. The fulcrum end 106 can be of any shape and size suitable for acting as a fulcrum, so as to provide extra leverage to a user of the multi-function tool 100. In this figure, the fulcrum end 106 is curved, while in other embodiments the fulcrum end 106 may be angled, for example.

The fissure 107 located at the fulcrum end 106 of the prying bar 102 can be of such dimensions so as to be capable of removing nails. In the embodiment shown, the prying bar 102 has a hexagonal cross-section. In other embodiments, the cross-section can be cylindrical, or I-beam shaped. The prying bar 102 can be made of steel, titanium, or any other material of substantial weight and hardness to accomplish the prying functions required in the ordinary course of demolition and/or manipulation of physical objects in the course of construction or demolition work, or the like.

The gripping pliers 104 can be rigidly attached to the prying bar 102 by being welded to the prying bar 102. Alternatively, the gripping pliers 104 can be attached to the prying bar 102 in any other suitable manner readily apparent to one of ordinary skill in the art, such as being screwed and/or bolted to the prying bar 102, for example. In the embodiment shown, the gripping pliers 104 are welded directly to the prying bar 102. In alternative embodiments, the gripping pliers 104 can be attached to the prying bar 102 via an intermediate attachment element (as shown in subsequent figures). In this embodiment, the gripping pliers 104 are attached to the prying bar 102 via a single attachment region, while in other embodiments the gripping pliers 104 can be attached to the prying bar 102 via a plurality of connecting regions.

The gripping pliers 104 can be locking pliers and/or a locking wrench, and in certain embodiments the gripping pliers 104 can be vise grips. In the embodiment shown, the gripping pliers 104 include grippers 110 capable of providing strong gripping action. In some embodiments, the grippers 110 are made substantially from steel. Alternatively, such grippers 110 can be made of any other hard substance capable of providing strong gripping action.

In the embodiment shown, grippers 110 are positioned near the fulcrum end 106 of the prying bar 102. Different configurations including different positions of the gripping pliers 104 relative to the prying bar 102 can provide for different advantages in the demolition process. As shown in the current figure, the gripping pliers 104 are aligned substantially parallel to the prying bar 102, and are positioned so as to enable a user to use the prying bar 102 as a lever for applying additional force to an object being gripped by the gripping pliers 104.

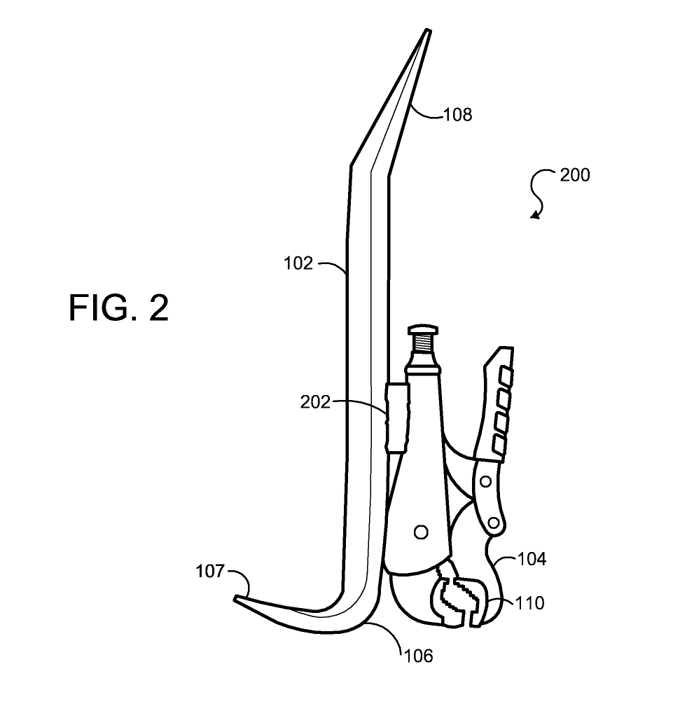

FIG. 2 is a side-view illustration of an alternative embodiment of the multi-function tool. In this embodiment of the multi-function tool 200, gripping pliers 104 are attached to a prying bar 102 with a smaller shaft than the prying bar 102 of the embodiment shown in FIG. 1. Different size embodiments may be appropriate for different kinds of construction and/or demolition, or the like. For example, a multi-function tool with a shorter prying bar 102, such as the embodiment shown in this figure, can be more useful than an embodiment with a longer prying bar 102, if the multi-function tool must be operated in a smaller, more confined space than is typical for a longer prying bar.

Furthermore, in FIG. 2, the gripping pliers 104 are attached to the prying bar 102 via two attachment regions, one of the attachment regions 202 being an intermediate attachment element. Such intermediate attachment element 202 can be made of metal, for example, so as to provide structural support.

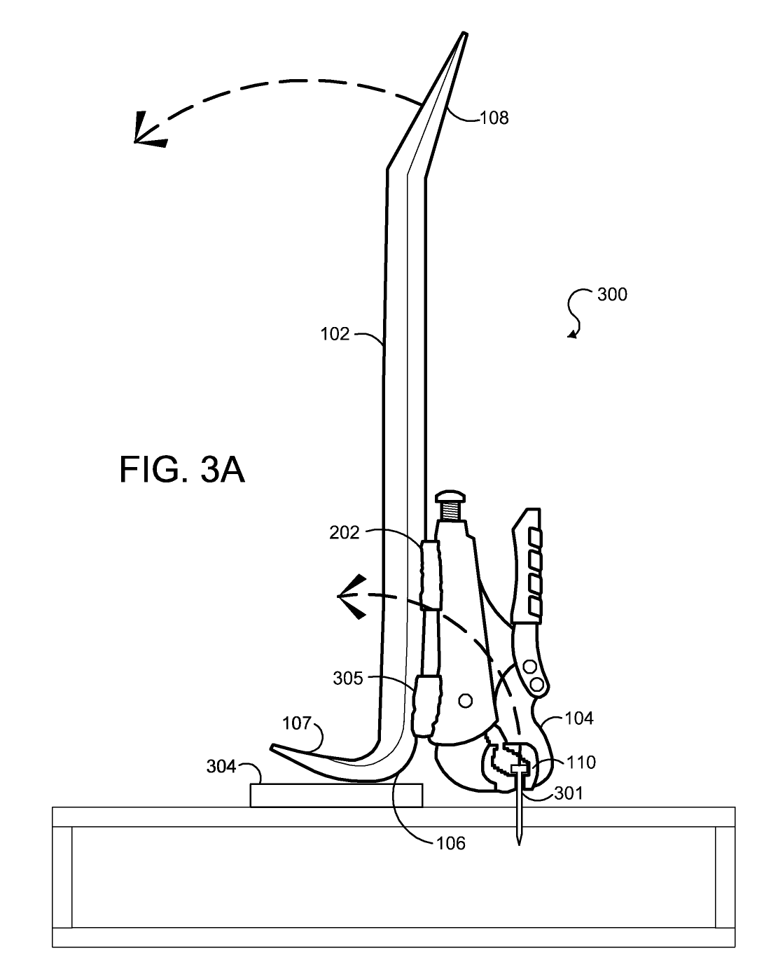

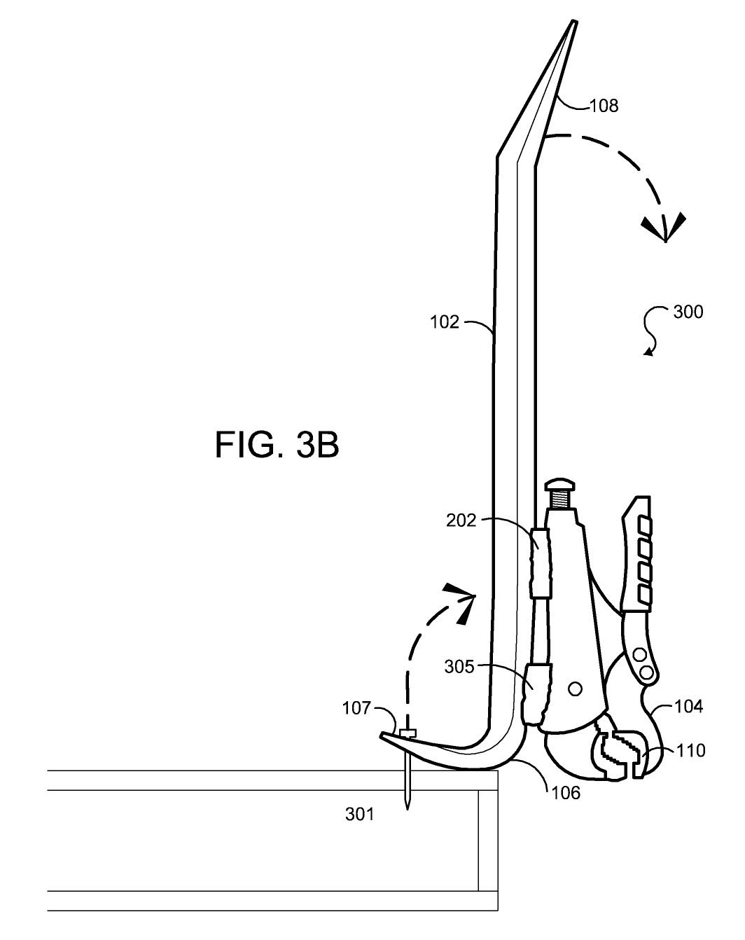

FIG. 3A is a side-view illustration of another embodiment of the multi-function tool 300 being used to pull a nail out of a board with gripping pliers, using a prying bar for leverage. The embodiment shown includes two intermediate attachment elements 202, 305, by which the gripping pliers 104 are attached to the prying bar 102.

In FIG. 3A, the prying bar 102 is used strictly to provide enhanced leverage for the gripping pliers 104. The grippers 110 of the gripping pliers 104 are used to grip the nail 301. The prying bar 102 is positioned vertically on a support block 304, which enables the multi-function tool 100 to be positioned properly for gripping the nail 301. The fulcrum end 106 of the prying bar is placed on the support block 304, and the opposite, angled handle end 108 of the prying bar 102 is pulled so as to enable the prying bar 102 to act as a lever, thereby providing the force required for the gripping pliers 104 to remove the nail 301 from the board 302 in which the nail 301 is embedded.

FIG. 3B is a side-view illustration of the embodiment of FIG. 3A being used as a regular prying bar to remove the nail 301. A user can still use the prying bar 102 function in the same manner that prying bars are typically used, for prying, removing nails, and other typical functions of prying bars. In the embodiment shown, the prying bar 102 is being used to remove a nail 301 from a board 302. The nail 301 is wedged within the fissure 107 of the prying bar 102, and the angled end 108 of the prying bar 102 is pulled so as enable the prying bar 102 to act as a lever, thereby facilitating removal of the nail 301 by the prying bar 102 as the nail is wedged 301 within the fissure 107.

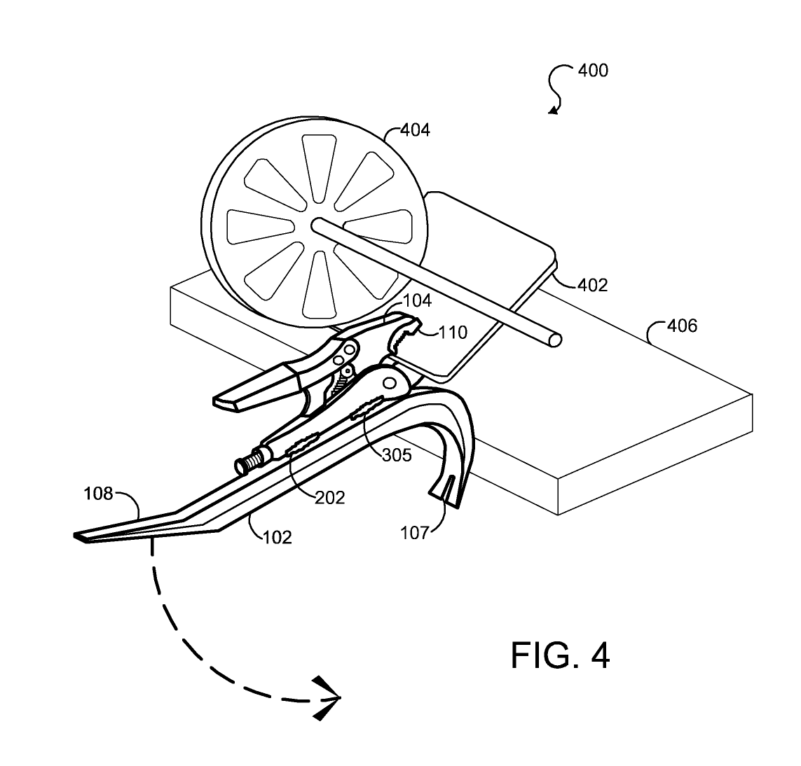

FIG. 4 is an oblique side-view illustration of an embodiment of the multi-function tool being used to provide extra leverage for enhanced gripping of a skid plate. In this embodiment 400, the prying bar 102 is used to provide leverage so as to provide enhanced gripping of the gripping pliers 104. The grippers 110 of the gripping pliers 104 are shown gripping a skid plate 402 so as to pull it away from a brake disc 404 and return the skid plate 402 to its proper position. The fulcrum end 106 of the prying bar 102 is pressed against a platform such as a truck bed platform 406, and a handle end 108 of the prying bar that lies opposite the grippers is pulled downwards so as to provide enhanced leverage to the gripping action of the grippers 110.

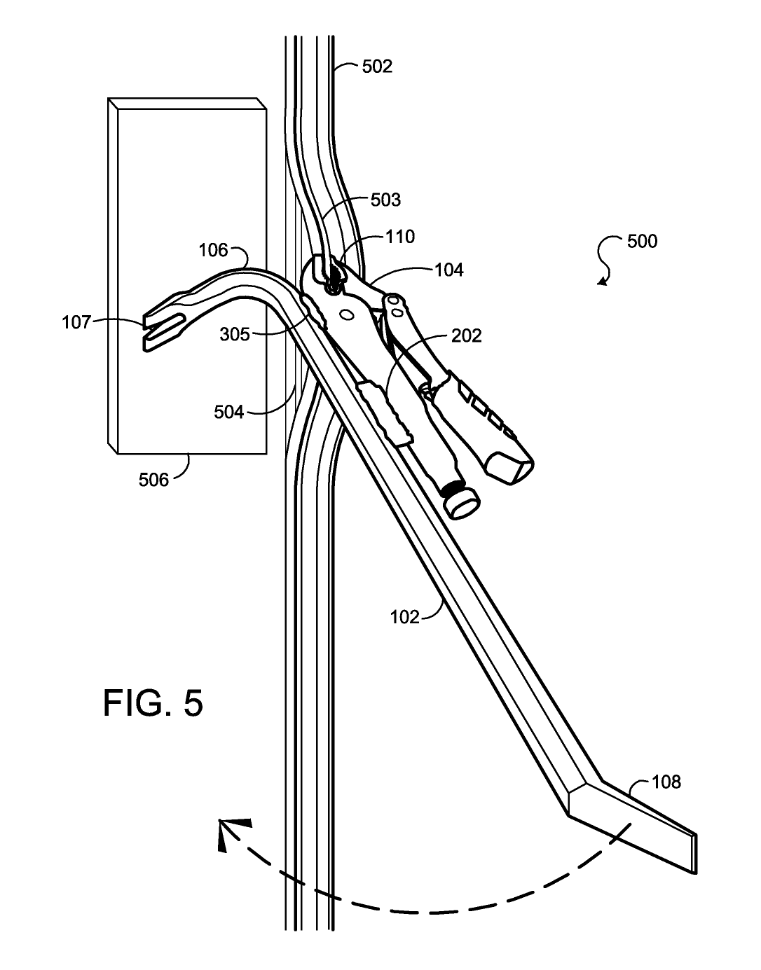

FIG. 5 is an illustration of an embodiment of the multi-function tool being used to provide extra leverage for enhanced gripping of a window extrusion. In this embodiment 500, the prying bar 102 is used to provide leverage so as to provide enhanced gripping of the gripping pliers 104. The grippers 110 of the gripping pliers 104 are shown gripping a protruded portion 503 of the window extrusion 502 currently positioned in a channel 504. The window extrusion 502 can be manipulated for purposes of repositioning in the channel 504 or removal from the channel 504, for example. The fulcrum end 106 of the prying bar 102 is pressed against a wooden block 506 in the embodiment shown. The angled end 108 of the prying bar that lies opposite the grippers 108 is pulled leftwards, so as to provide enhanced leverage to the gripping action of the grippers 110. In the manner described, the window extrusion 502 can be manipulated and pulled out of the channel 504.

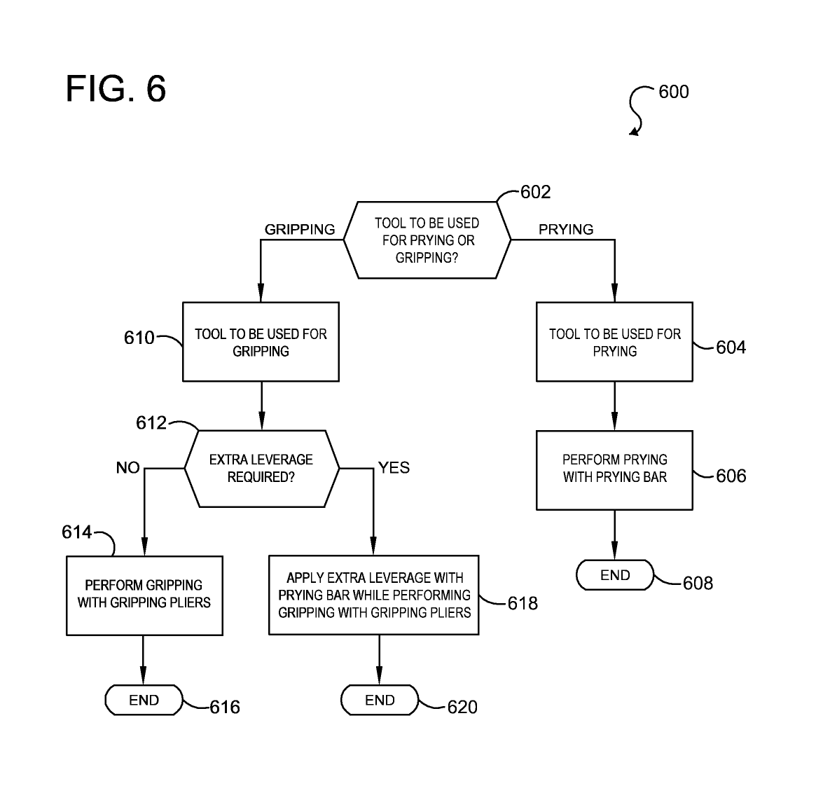

FIG. 6 is a flowchart detailing the steps of use of an embodiment of the multi-function tool. In the flowchart as shown 600, the specific usage of the tool in a given instance is to be determined 602. If the tool is to be used for prying 602, the prying bar is used for prying 604, as a prying bar would typically be used 606. If the tool is to be used for gripping 610, the user should determine whether extra leverage is required 612. If so, the user can apply extra leverage with the prying bar, while performing gripping with the gripping pliers 618. If no extra leverage is required 612, the gripping pliers can be used for gripping in the same manner as gripping pliers would typically be used 614.

Other modifications and implementations will occur to those skilled in the art without departing from the spirit and the scope of the invention as claimed. Accordingly, the above description is not intended to limit the invention except as indicated in the following claims.

What is claimed is:

1. A multi-function tool for prying and leverage-enhanced gripping, the multi-function tool comprising:
a prying bar, the prying bar having at least one fulcrum end; and
gripping pliers attached to the prying bar in substantially parallel alignment, the gripping pliers having a pair of grippers for gripping an object, the grippers being located proximal to the fulcrum end, so as to enable a user to use the prying bar for applying leverage to the gripping pliers while the grippers grip an object, thereby providing leverage-enhanced gripping of the object.

2. The multi-function of claim 1, wherein the at least one fulcrum end is curved.

3. The multi-function of claim 1, wherein at least one end of the prying bar includes an angled bend.

4. The multi-function of claim 1, wherein at least one end of the prying bar includes a fissure capable of removing nails.

5. The multi-function of claim 1, wherein a shaft of the prying bar is shaped in one of:
a circular cross-section;
a hexagonal cross-section; and
an I-beam cross-section.

6. The multi-function of claim 1, wherein the prying bar is made from one of:
steel;
iron; and
titanium.

7. The multi-function of claim 1, wherein the prying bar is a crowbar.

8. The multi-function tool of claim 1, wherein the gripping pliers are locking pliers.

9. The multi-function tool of claim 1, wherein the gripping pliers are a locking wrench.

10. The multi-function tool of claim 1, wherein the gripping pliers are vise grips.

11. The multi-function tool of claim 1, wherein the grippers are made substantially from steel.

12. The multi-function tool of claim 1, wherein the gripping pliers are attached directly to the prying bar.

13. The multi-function tool of claim 1, wherein the gripping pliers are attached via an intermediary attachment element.

14. The multi-function tool of claim 1, wherein the gripping pliers are welded to the prying bar.

15. The multi-function tool of claim 1, wherein the gripping pliers are one of:
screwed to the prying bar; and
bolted to the prying bar.
